(19) United States
(12) Patent Application Publication
(10) Pub. No.: US 2026/0347562 A1
(43) Pub. Date: Nov. 5, 2026

(54) CHEMOLYSIS PROCESS FOR POLYISOCYANURATE FOAMS

(71) Applicant: Stepan Company, Northbrook, IL (US)

(72) Inventor: Carl William LISKEY, Chicago, IL (US)

(21) Appl. No.: 19/119,466

(22) PCT Filed: Sep. 14, 2023
(86) PCT No.: PCT/US2023/032683

§ 371 Date: Apr. 9, 2025

Related U.S. Application Data
(60) Provisional application No. 63/414,967, filed on Oct. 11, 2022.

(51) Int. Cl. C08J 11/24; C08G 18/42; C08G 18/76

(52) U.S. Cl. CPC C08J 11/24; C08G 18/42; C08G 18/76; C08G 2110/0025; C08G 2110/005; C08J 2201/00; C08J 2375/04

(57) ABSTRACT

A process comprising:
reacting a C₄-C₁₀ difunctional aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP;
reacting the chemolysis reagent with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

### FIELD OF THE INVENTION

The invention relates to a process for the chemolysis of recycled rigid polyurethane and polyisocyanurate foams using a chemolysis reagent, to produce a polyol which is then used to produce new rigid foam.

### BACKGROUND OF THE INVENTION

Polyurethane (PUR) and polyisocyanurate (PIR) rigid foams are frequently used in construction applications due to their excellent insulation characteristics. These are highly cross-linked materials that provide good foam strength, thermal stability and insulation values. Recently, regulations and sustainability efforts have put a heightened emphasis on the circularity of materials, including in the construction industry. However, because these materials are highly cross-linked thermosets, they are difficult to reprocess or repurpose at the end of their lifetime. Also, for true circularity, the rigid foam should be able to be converted back into a foam instead of being downcycled into less valuable materials.

Glycolysis of PUR/PIR linkages is well known in the industry. Typically, in glycolysis diethylene glycol, or some other low molecular weight glycol is reacted with foam in the presence of a catalyst to prepare a glycolyzed, liquid or polyol product, sometimes referred to as a recyclate. The most common route for chemolysis of PUR and PIR foams utilize diethylene glycol (DEG) as the glycolysis reagent. The resulting polyols typically have high OHv values (>550 mg KOH/g), high viscosity, and cannot be utilized in PIR formulations at high concentrations (U.S. Pat. Nos. 5,556,889, 6,087,409, and Polymers 2020, 12, 1752). Another example utilizes dipropylene glycol to glycolyze PIR foams (Polymer Degradation and Stability, 2018, 156, 151), which enables lower hydroxyl values of the recyclate polyol. However, the resulting recyclate polyol exhibits very high viscosity >15,000 cP at 40% incorporation and still high levels of free glycol would be observed. Furthermore, dipropylene glycol contains secondary hydroxyl functionalities, which exhibit poor reactivity in a PIR formulations. Therefore, the overall recycled content of PIR foams with these recyclate polyols are relatively low under workable viscosities.

Another strategy is to incorporate the recyclate polyols into a prepolymer as disclosed in U.S. Patent Application Publication No. 2020/0040153. While possible in flexible foam applications, this strategy cannot be used to prepare rigid PIR foams due to the high viscosity of the intermediates. The resulting products also lead to foams with poor compressive strength.

Due to the difficulty in improving the glycolysis, efforts have been devoted to processing or dispersing the intermediates. U.S. Patent Application Publication No. 20050096400 teaches creating a polyurethane suspension via dissolution in a solvent followed by addition of a non-solvent, and evaporation of the solvent. The resulting polyol mixture can be used in flexible foam applications. EP0835901 teaches a process for improving the rate of recyclate chemolysis. However, since the glycolysis is conducted with low molecular weight glycols (ethylene glycol or diethylene glycol), the resulting polyol still contains very high hydroxyl values and viscosity. Clearly, a continuing need remains to improve the chemical recycling or chemolysis of rigid polyurethane and polyisocyanurate foams. Applicants have unexpectedly discovered a process for preparing a chemolysis agent that can be reacted with recycled rigid PIR or PUR foams to produce a polyol with excellent properties that can be further reacted to form a polyol which can be used in high concentrations for new foam production. Such a process represents significant progress in achieving the goal of true circularity, while advancing UN Sustainable Development Goals (“SDG”). By developing a process for recycling existing foam to form polyols for the eventual production of new foams, the process not only minimizes the use of chemical raw materials, but also reduces solid waste for disposal at landfill. Moreover, the new foams will largely be used in thermal insulation applications to reduce energy usage. In addition, the global warming potential of a polyol based on recycled foam should be reduced compared to polyols based on virgin materials derived from petrochemicals. These benefits further SDG #9, (Industry, Innovation, and Infrastructure); SDG #11 (Sustainable Cities and Communities); SDG #12 (Responsible Consumption and Production); and SDG #13 (Climate Action).

### SUMMARY OF THE INVENTION

In one embodiment, the invention relates to a process comprising:
reacting a C₄-C₁₀ difunctional aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP;
reacting the chemolysis reagent with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

In another embodiment, the invention relates to a process comprising:
reacting a C₃-C₁₀ hydroxyl-containing aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP;
reacting the chemolysis reagent with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

In still another embodiment, the invention relates to a process for producing a rigid PUR or PIR foam comprising reacting:
a polyisocyanate;
water;
a surfactant;
a polyol stream comprising 0.0 to 99.0 wt % of a polyester polyol and 1.0 to 100.0 wt % of a first polyol;
optionally, a urethane catalyst, an isocyanurate catalyst, or both;
optionally, a blowing agent; and
optionally, a flame retardant.

In another embodiment, the invention relates to a process comprising:
reacting an aliphatic polyester polyol having a hydroxyl value of 400 to 900 mg KOH/g and a viscosity of 10 to 500 cP with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

### BRIEF DESCRIPTION OF THE DRAWINGS

FIG. 1 shows insulation properties of rPIR Foams.

FIG. 2 shows flammability properties of rPIR foams via hot plate tests.

FIG. 3 shows Thermogravimetric Analysis of Recyclate Polyols.

### DETAILED DESCRIPTION OF THE INVENTION

In one embodiment, the current subject matter relates to a process comprising reacting a C₄-C₁₀ difunctional aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP. Then the chemolysis reagent is reacted with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

### Difunctional Aliphatic Acid Stream

The difunctional aliphatic acid stream is selected from C₄-C₁₀ difunctional aliphatic acids. Preferably, the difunctional aliphatic acid stream is selected from adipic acid, succinic acid, azelaic acid, sebacic acid or mixtures thereof. More preferably, the aliphatic acid stream is adipic acid.

### Glycol Stream

The glycol stream is selected from monoethylene glycol, diethylene glycol, propylene glycol, triethylene glycol, tetraethylene glycol or mixtures thereof. Preferably, the glycol stream is selected from Diethylene glycol, triethylene glycol and tetraethylene glycol.

### Chemolysis Reagent

The chemolysis reagent produced from the reaction of the glycol stream and the difunctional aliphatic acid stream has a hydroxyl value of 400 to 900 mg KOH/g, measured according to ASTM E222, and a viscosity of 10 to 500 cP at 25 °C, measured by a Brookfield viscometer Model LVPV. Preferably, the hydroxyl value of the chemolysis agent is 400 to 800 mg KOH/g. Preferably, the chemolysis agent comprises 10.0 to 50.0 wt % of aliphatic acid and 50.0 to 90.0 wt % glycol.

The process of reacting the C₄-C₁₀ difunctional aliphatic acid stream with the glycol stream is preferably conducted at a temperature of 160 to 240 °C. More preferably, the temperature is 200 to 220 °C. Preferably, the reaction is conducted at a pressure of 0.1 to 1.0 atm. The reaction to form the chemolysis reagent is preferably conducted with a Sn or Ti based catalyst. Preferably, the catalyst is selected from titanium n-butoxide, titanium lactic acid chelate or titanium propoxide

### Recycled Rigid Foam Material

The recycled rigid foam material is selected from recycled rigid polyurethane foam, rigid polyisocyanurate foam or mixtures thereof. Typically, both urethane and isocyanurate functionalities are found in these foams, which are principally used in insulating materials such as laminate board, metal panel board, or appliance insulation.

Preferably, the recycled foam material has a density of 1.0 to 3.0 lb/ft³. More preferably, the density is 1.5 to 2.5 lb/ft³. Preferably, the recycled foam material has an isocyanate to hydroxyl ratio of 100 to 400. More preferably, the ratio of isocyanate to hydroxyl is 105 to 300. Preferably, the recycled foam material is polyisocyanurate foam. When the recycled foam material is polyisocyanurate foam, the foam preferably has an isocyanate to hydroxyl ratio of 240 to 400.

### First Polyol

The first polyol is produced from the reaction between a recycled rigid foam material and the chemolysis reagent. The first polyol has a recycled foam content of up to 55 wt %, a hydroxyl value of less than 550 mg KOH/g, measured according to ASTM E222, a viscosity of less than 10,000 cP at 25 °C, measured by a Brookfield viscometer Model LVPV and a free glycol, level, measured according to calibrated gas chromatography or gel-permeation chromatography, of less than 35 wt %. Preferably, the viscosity of the first polyol is less than 7,000 cP. Preferably, the hydroxyl level of the first polyol is less than 450 KOH/g. Preferably, the free glycol level is less than 25 wt %.

Preferably, the reaction of the chemolysis reagent with the recycled rigid foam material is conducted at a temperature of 160 to 240 °C. More preferably, the temperature is 200 to 220 °C. Preferably, the reaction of the chemolysis reagent with the recycled rigid foam material is conducted at a pressure of 0.1 to 1.0 atm. Preferably, the reaction of the chemolysis reagent with the recycled rigid foam material is conducted with a catalyst selected from potassium hydroxide, potassium acetate, lithium acetate, or zinc acetate.

In another embodiment, the invention relates to a process comprising:
reacting a C₃-C₁₀ hydroxyl-containing aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP;
reacting the chemolysis reagent with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

### Aliphatic Acid Stream

The aliphatic acid stream is selected from C₃-C₁₀ hydroxyl-containing aliphatic acids. Preferably, the C₃-C₁₀ hydroxyl-containing aliphatic acid stream is selected from hydroxycarproic acid, hydroxypropionic acid, hydroxypentanoic acid or mixtures thereof. The hydroxyl-containing aliphatic stream may also preferably be selected from dehydrated hydroxy-containing aliphatic acid selected from caprolactone, valerolactone or mixtures thereof. Finally, the hydroxyl-containing aliphatic stream may also preferably be selected from oligomeric mixtures of the hydroxyl-containing aliphatic stream.

In still another embodiment, the current invention relates to a process comprising reacting a glycol adipate chemolysis agent having a hydroxyl value of 400 to 900 mg KOH/g and a viscosity of 10 to 500 cP with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %. Suitable glycol adipates include the polyester polyol derived from diethylene glycol and adipic acid with a hydroxyl value of less than 600 mg KOH/g.

In another embodiment the present subject matter relates to a process for producing a rigid PUR or PIR foam comprising reacting a polyisocyanate, water, a surfactant and a polyol stream. Water is used in an amount within the range of 0.1 to 3 wt % based on the amount of polyester polyol in the rigid foam formulation. Preferably, the water is in the range of 0.2 to 1.0 wt %. More preferably, the water is present in an amount from 0.2 to 0.6 wt %. The polyol stream comprises 0.0 to 99.0 wt % of a polyester polyol and 1.0 to 100.0 wt % of the first polyol described above. Optionally, the reaction includes a urethane catalyst, an isocyanurate catalyst, or both. Optionally, the reaction can also include a blowing agent, a surfactant, and a flame retardant.

### Rigid Foams

Rigid foams produced from the above process can be formulated over a wide index range. As used herein, “index” means the ratio of isocyanate to hydroxyl equivalents multiplied by 100. Rigid PU foams are produced at a relatively low index, e.g., 90 to 150, while rigid PIR foams are usually made at relatively high index, e.g., 180 to 350.

### Polyester Polyol

When present, the polyester polyols are preferably selected from aromatic polyester polyols. Suitable aromatic polyester polyols are well known, and many are commercially available. The polyester polyols can be produced from aromatic dicarboxylic acids or their derivatives, especially one or more phthalate-based compounds or compositions (e.g., terephthalic acid, dimethyl terephthalate, DMT bottoms, phthalic anhydride, isophthalic acid, and the like) and one or more glycols (e.g., ethylene glycol, diethylene glycol, triethylene glycol, propylene glycol, dipropylene glycol, 1,3-propanediol, 2-methyl-1,3-propanediol, glycerin, trimethylolpropane, and the like), optionally with some aliphatic dicarboxylic acid (e.g., adipic acid, succinic acid) content. In one preferred aspect, the aromatic polyester polyol comprises recurring units from phthalic anhydride and diethylene glycol.

Commercially available aromatic polyester polyols include products available from Stepan Company under the STEPANPOL® mark, particularly the STEPANPOL® PS-series of products, such as STEPANPOL® PS-1812, STEPANPOL® PS-1912, STEPANPOL® PS-1952, STEPANPOL® PS-2002, STEPANPOL® PS-2080, STEPANPOL® PS-2352, STEPANPOL® PS-2412, STEPANPOL® PS-2520, STEPANPOL® PS-2602, STEPANPOL® PS-3021, STEPANPOL® PS-3422, STEPANPOL® PS-3524, and TERATE® mark, such as TERATE® HT-5503, TERATE® HT-5510 TERATE® HT-2006V and the like. Suitable aromatic polyester polyols are also available from Huntsman (TEROL® polyols).

The aromatic polyester polyols have hydroxyl numbers, as measured by ASTM E-222, within the range of 150 to 400 mg KOH/g, from 160 to 350 mg KOH/g, or in some aspects from 200 to 300 mg KOH/g, or from 230 to 250 mg KOH/g. The polyols have, in some aspects, number-average molecular weights from 280 to 1100 g/mol, or from 300 to 700 g/mol., measured according to ASTM E222. The aromatic polyester polyols preferably have acid values, measured according to ASTM E301 of less than 5 mg KOH/g, or less than 2 mg KOH/g, or less than 1 mg KOH/g. The polyols have viscosities, measured at 25 °C with a Brookfield viscometer Model LVPV, of less than 25,000 cP at °C, less than 10,000 cP at 25 °C, or less than 5,000 cP at 25 °C. In some aspects, the viscosities are within the range of 100 cP to 10,000 cP at 25 °C or from 500 cP to 5,000 cP at 25 °C.

### Polyisocyanates

The polyisocyanates suitable for use are well known, and many are commercially available from Dow Chemical (under the PAPI™, ISONATE®, and VORONATE™ marks), Evonik (VESTANAT®), BASF (LUPRANATE®), Covestro (MONDUR® and DESMODUR®), Huntsman (RUBINATE®), and other suppliers of polyurethane intermediates. Polyisocyanates suitable for use have average NCO functionalities (reactive groups per molecule) within the range of 2.0 to 3.0. The polyisocyanate can be aromatic or aliphatic. Aromatic polyisocyanates include, e.g., toluene diisocyanates (TDI), 4,4′-diphenylmethane diisocyanates (MDI), or polymeric diisocyanates (p-MDI), or the like. Aliphatic polyisocyanates include, e.g., hexamethylene diisocyanate (HDI), hydrogenated MDI, cyclohexane diisocyanate (CHDI), isophorone diisocyanate (IPDI), trimethyl or tetramethylhexamethylene diisocyanate (TMXDI), or the like. Aromatic polyisocyanates, especially polymeric MDIs having NCO functionalities within the range of 2.3 to 3.0, are preferred. Suitable polymeric MDIs include, for instance, LUPRANATE® M-10 (average NCO functionality=2.3) and LUPRANATE® M-20 (average NCO functionality=2.7), products of BASF, as well as MONDUR® 489 (modified polymeric MDI, average NCO functionality=2.9), product of Covestro. Mixtures of different polyisocyanates can be used. Dimerized and trimerized polyisocyanates can be used. In some aspects, aromatic polyisocyanates, e.g., p-MDI, are preferred.

### Catalysts

When a catalyst is used in the process for producing a rigid PUR or PIR foam, the catalyst includes a urethane catalyst, an isocyanurate catalyst, or both. Catalysts suitable for use include compounds that catalyze the reaction of isocyanates and water (“blowing catalysts”) and compounds that catalyze the formation of urethane, urea, or isocyanurate linkages (“PU catalysts,” “PIR catalysts,” or “trimerization catalysts”).

Amine catalysts are generally tertiary amines or alkanolamines and their mixtures with a diluent, typically a glycol such as dipropylene glycol. Examples include bis(2-dimethylaminoethyl)ether, N,N-dimethylaminopropylamine, N,N-dimethylethanolamine, triethylenediamine, benzyldimethylamine, N,N-dimethylcyclohexylamine, N,N,N′,N′,N″-pentamethyldiethylenetriamine (PMDETA), diethanolamine, N-ethylmorpholine, N,N,N′N′-tetramethylbutanediamine, 1,4-diaza[2.2.2]bicyclooctane, and the like, and combinations thereof. Examples include POLYCAT® 5 or POLYCAT® 8 (Evonik) and NIAX® A-1 or NIAX® A-99 (Momentive).

Other catalysts include carboxylates (e.g., potassium acetate, potassium octoate), organotin compounds (e.g., dibutyltin dilaurate, stannous octoate), quaternary ammonium compounds (e.g., N-(2-hydroxyethyl)trimethylammonium chloride), and the like, and combinations thereof.

Suitable catalysts are available from Evonik (TEGOAMIN® amine catalysts, KOSMOS® metal catalysts, DABCO® TMR catalysts, DABCO® K-15 catalysts, and POLYCAT® catalysts), Huntsman (JEFFCAT® catalysts), King Industries (K-KAT® catalysts), Momentive (NIAX® catalysts), Galata Chemicals (FOMREZ® organotin catalysts), and others.

### Blowing Agents

When blowing agents are used in the process for producing a rigid PUR or PIR foam, the blowing agents can include aliphatic or cycloaliphatic C₄-C₆ hydrocarbons, water, mono- and polycarboxylic acids and their salts, tertiary alcohols, chlorofluorocarbons (CFCs), hydrochlorofluorocarbons (HCFCs), halogenated hydrocarbons, hydrofluoroolefins (HFOs), and the like, and their mixtures. For further examples of suitable blowing agents, see U.S. Pat. No. 6,359,022, the teachings of which are incorporated herein by reference.

### Surfactants

Surfactants are used in the process for producing a rigid PUR or PIR foam to enable the production of a closed-cell rigid foam. Representative examples include products available commercially from Evonik, Dow Chemical, Siltech, Momentive Performance Materials, and in particularly include TEGOSTAB® B silicone surfactants (Evonik), SILSTAB® silicone surfactants (Siltech), VORASURF™ surfactants (Dow), NIAX® surfactants (Momentive) and others. Other suitable surfactants are polysiloxanes or other silicon-based surfactants.

### Flame Retardants

When flame retardants are used in the process for producing a rigid PUR or PIR foam, suitable flame-retardant additives include solid or liquid compounds containing phosphorus, chlorine, bromine, boron, or combinations of these elements. Examples include brominated phthalate diols, ammonium polyphosphates, triethyl phosphate, tris(2-chloroisopropyl) phosphate, tetrakis(2-chloroethyl)ethylene diphosphate, tris(p-chloroethyl) phosphate, tris(2,3-dibromopropyl) phosphate, and the like.

### Water

Water is used as a reactant in the process for producing a rigid PUR or PIR foam. The amount of water used depends on several factors, including the amount of polyisocyanate, the desired index, the nature and amount of the polyester polyol, the nature and amount of the fatty acid derivative, which catalysts, surfactants, and blowing agents are used, and other factors. Generally, water is used in an amount within the range of 0.1 to 3 wt. %, 0.2 to 1 wt. %, or 0.2 to 0.6 wt. % based on the amount of polyester polyol in the rigid foam formulation.

### EXAMPLES

The following Examples further detail and explain the inventive process. These examples merely illustrate the invention. Those skilled in the art will recognize many variations that are within the spirit of the invention and scope of the claims.

### Chemolysis Procedure and Polyol Properties

### Example 1: Recyclate Polyol 1

The chemolysis agent is prepared by reacting adipic acid with diethylene glycol. The target of the hydroxyl number was 650 mg KOH/g. Adipic acid (156 g), diethylene glycol (482 g) and Tyzor®-LA (860 ppm) are charged to a 4-neck round bottomed flask equipped with overhead stirring, a thermocouple, nitrogen sparge inlet and a column attached to a reflux condenser. The reactor is heated to 220 °C under nitrogen sparge until the acid value is <5 mg KOH/g and nearly the theoretical distillate is collected.

The polyisocyanurate core foam (index 290) is charged to the round bottom flask in 15 g increments followed by potassium acetate (up to 1 wt %) as a catalyst. The foam is charged continuously as it dissolves until 27% recycled content in the polyol is achieved. Additional catalyst is added if the reaction rate slows. The recyclate polyol is used without further purification.

### Example 2: Recyclate Polyol 2

The chemolysis agent from Example 1 is charged to a 4-neck round bottomed flask equipped with overhead stirring, a thermocouple, nitrogen inlet and a column attached to a reflux condenser. The polyisocyanurate core foam (index 290) is charged to the round bottom flask in 15 g increments followed by potassium acetate (up to 1 wt %) as a catalyst. The foam is charged continuously as it dissolves until 40% recycled content in the polyol is achieved. Additional catalyst is added if the reaction rate slows. The recyclate polyol is used without further purification.

### Comparative Example 3

STEPANPOL® PS-2352 (aromatic polyester polyol, hydroxyl number about 240 mg KOH/g) is used as a polyol for making rigid foam.

### Comparative Example 4

A recyclate polyol based on diethylene glycol and polyisocyanurate foam with a hydroxyl number about 525 mg KOH/g and viscosity of 15,000 cP.

### Comparative Example 5

A recyclate polyol based on polyethylene glycol-200 (PEG-200) and polyisocyanurate foam with a hydroxyl number about 330 mg KOH/g and viscosity of 18,200 cP.

Recyclate polyol properties are shown in Table 1.

TABLE 1
Recyclate Polyol Properties

| | | rPIR | | |
|---|---|---|---|---|
| | Chemolysis | Content | OHv | Viscosity |
| Polyol | Reagent | (%) | (mg KOH/g) | (cP) |
| Example 1 | DEG-AA-DEG | 27 | 410 | 3,770 |
| Example 2 | DEG-AA-DEG | 40 | 400 | 5,550 |
| Comparative | None | none | 240 | 2,500-3,000 |
| Example 3 | | | | |
| (PS-2352) | | | | |
| Comparative | DEG | 55 | 525 | 15,000 |
| Example 4 | | | | |
| Comparative | PEG-200 | 40 | 333 | 18,200 |
| Example 5 | | | | |

### Rigid Polyisocyanurate Foams

Rigid polyisocyanurate foams are prepared with the general formulation shown in Table 2. The B-side blend (polyolester polyol, recyclate polyol, flame retardant, catalysts, surfactant, water and pentanes blowing agent) are mixed together with an overhead mixer. The B-side and MONDUR® 489 (polymeric MDI, product of Covestro) are conditioned at 20 °C for 2 hours prior to foaming. The two components are weighed into a one-quart cup and are mixed at >2500 rpm for 5 seconds, and the mixture is poured into a one-gallon cup. The cream and gel times are recorded and the catalyst is adjusted to match reactivity. Due to the varying hydroxyl values of the mixture, the index is adjusted to keep a constant A/B ratio. The crown is cut at 90 seconds. The foam properties are shown in Table 2.

TABLE 2
Polyisocyanurate Foam Formulation

| | Amount | Amount |
|---|---|---|
| Component | (Wt %) | (parts) |
| Polyol | 29.66 | 100 |
| TCPP | 3.86 | 13 |
| PMDETA | 0.11 | 0.50 |
| K-octoate | 1.19 | 5.5 |
| Silicone surfactant | 0.59 | 2.0 |
| water | 0.15 | 0.50 |
| Blowing Agent (pentanes) | 6.00 | 20.0 |
| A/B Ratio | 58.5/41.5 | |
| Target Density (pcf) | 1.90 | |

Table 3 shows improved compressive strength of the PIR foam compared to the control foam by up to 18%. While a polyether polyol can reduce the hydroxyl value relative to diethylene glycol, the foam has a lower compressive strength by up to 19%,

TABLE 3
Foam Properties based on Recyclate Polyols

| | % rPIR in | | Compressive Strength |
|---|---|---|---|
| Polyol | Foam | Index | (24 h, rel to control) |
| Comp Ex 3 | 0 | 300 | — |
| PS-2352 | | | |
| 90% PS-2352 | 1.6 | 300 | +2% |
| 10% Comp Ex 4 | | | |
| 66% PS-2352 | 5.3 | 240 | +7% |
| 34% Comp Ex 4 | | | |
| 60% PS-2352 | 3.2 | 240 | +5% |
| 40% Example 1 | | | |
| 60% PS-2352 | 5 | 240 | +18% |
| 40% Example 2 | | | |
| 49% PS-2352 | 6 | 235 | +16% |
| 51% Example 2 | | | |
| 58% PS-2352 | 5 | 260 | −19% |
| 42% Comp Ex 5 | | | |

### Thermal Conductivity Tests

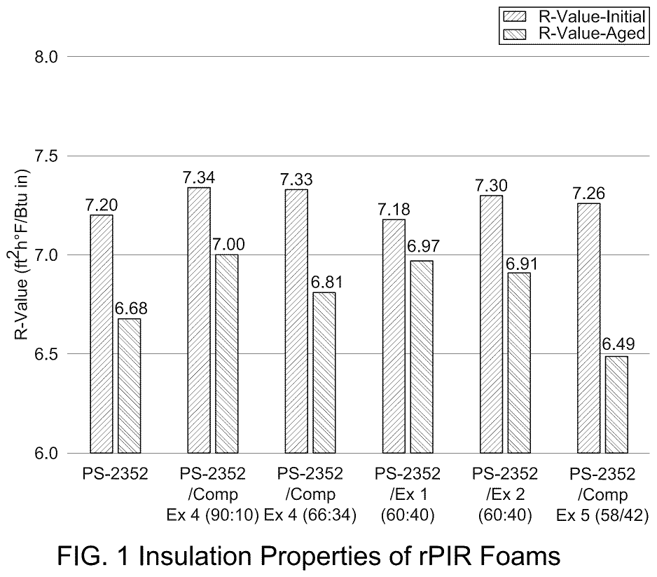

The foam sample were allowed to cure for 24 hours. Three pieces of core foam were cut (~0.5″ thick) 6″×6″. The foam was put in a LaserComp 3000 machine. The thermal conductivity was measured at a mean temp of 10 °C with a plate differential of 20 °C. The thermal conductivity was measured again after aging for 14 d. The results are shown in FIG. 1. FIG. 1 demonstrates that initial R-values of the inventive samples are similar to the control (PS-2352) sample, while the rate of aging is improved compared to the control sample. Comparative Example 5 with a polyether polyol as a chemolysis reagent shows poor aged R-value and rate of aging.

### Flammability Characteristics Via Hot Plate Tests

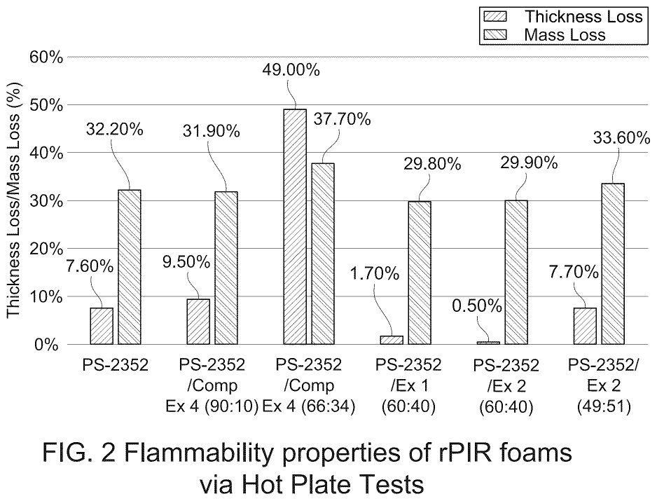

The foam samples are allowed to cure for at least 24 hours and cut to dimensions of 4″×4″×1.25″. The mass, thickness, and density are measured. Samples are placed on a preheated (1200 °C) hotplate for 15 min, during which time the temperature is gradually decreased to 1000 °C. Samples are weighed, cut in half to determine thickness, and analyzed for charring characteristics. A reduced mass loss and thickness loss indicates improved flammability properties for PIR foams. The results are shown in FIG. 2.

FIG. 2 demonstrates improved flammability properties of the inventive example compared to the DEG chemolyzed sample. Specifically, flammability properties are much worse for comparative example 4 when rPIR content approach 5% recycled content in foam (66/34 (PS-2352/Comp Ex 4)).

Thermal Stability based on Thermogravimetric Analysis (TGA)

TGA was conducted using a Discovery TGA instrument (TA instruments). Polyol samples (30-40 mg) are tested in air at 25 ml/min flow rate. Temperature is increased from 25 °C to 700 °C at 10 °C/min. Data is plotted as mass retention (%) versus temperature. A higher mass retention at a given temperature indicates higher thermal stability.

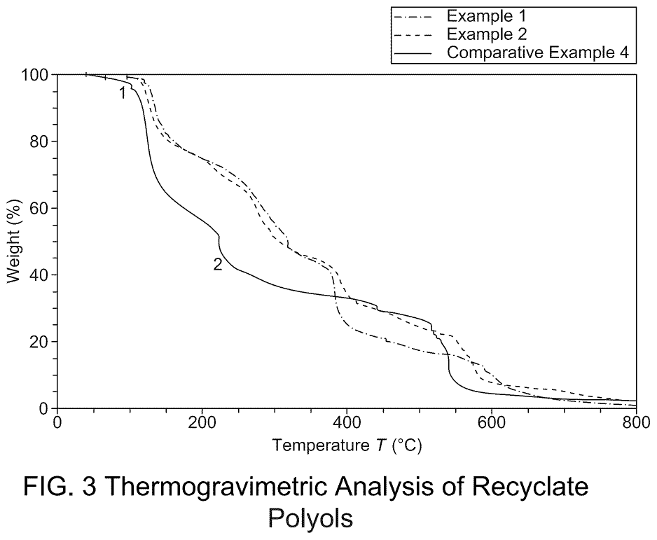

FIG. 3 shows improved mass retention of the inventive sample compared to the recyclate polyol chemolyzed with diethylene glycol. This further demonstrates the improved flammability performance of the inventive recyclate polyols.

Other features, advantages and embodiments of the invention disclosed herein will be readily apparent to those exercising ordinary skill after reading the foregoing disclosure. In this regard, while specific embodiments of the invention have been described in considerable detail, variations and modifications of these embodiments can be effected without departing from the spirit and scope of the invention as described and claimed.

1. A process comprising:
reacting a C₄-C₁₀ difunctional aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP;
reacting the chemolysis reagent with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

2. The process of claim 1 wherein the recycled foam material has a density of 1.0 to 3.0 lb/ft³.

3. (canceled)

4. The process of claim 1 wherein the recycled foam material has an isocyanate to hydroxyl ratio of 100 to 400.

5. (canceled)

6. The process of claim 1 wherein the recycled rigid foam material is polyisocyanurate foam.

7-10. (canceled)

11. The process of claim 1 wherein the difunctional aliphatic stream is selected from succinic acid, adipic acid, azelaic acid or mixtures thereof.

12. The process of claim 1 wherein the hydroxyl value of the chemolysis agent is 400 to 800 mg KOH/g.

13. The process of claim 1 wherein the chemolysis agent comprises 10.0 to 50.0 wt % of aliphatic acid and 50.0 to 90.0 wt % glycol.

14. The process of claim 1 wherein the reaction of the C₄-C₁₀ difunctional aliphatic acid stream with the glycol stream is conducted at a temperature of 160 to 240 °C.

15. (canceled)

16. (canceled)

17. The process of claim 1 wherein the reaction of the C₄-C₁₀ difunctional aliphatic acid stream with the glycol stream is conducted with a Sn or Ti based catalyst.

18. (canceled)

19. The process of claim 1 wherein the reaction of the C₄-C₁₀ difunctional aliphatic acid stream with the glycol stream is conducted until the chemolysis reagent has an acid value of less than 5.0 mg KOH/g.

20-22. (canceled)

23. The process of claim 1 wherein the reaction of the chemolysis reagent with the recycled rigid foam material is conducted with a catalyst selected from potassium hydroxide, potassium acetate, lithium acetate, or zinc acetate.

24. A process comprising:
reacting a C₃-C₁₀ hydroxyl-containing aliphatic acid stream with a glycol stream selected from monoethylene glycol, diethylene glycol, propylene glycol, triethylene glycol, tetraethylene glycol or mixtures thereof, thereby forming a chemolysis reagent having a hydroxyl value of 400 to 900 mg KOH/g and a viscosity of 10 to 500 cP;
reacting the chemolysis reagent with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

25-27. (canceled)

28. A process comprising:
reacting an aliphatic polyester polyol having a hydroxyl value of 400 to 900 mg KOH/g and a viscosity of 10 to 500 cP with a recycled rigid foam material selected from rigid polyurethane foam, rigid polyisocyanurate foam or mixtures thereof, thereby forming a first polyol having a recycled foam content of up to 55 wt %, a hydroxyl value of less than 550 mg KOH/g, a viscosity of less than 10,000 cP, and a free glycol level of less than 35 wt %.

29. A process for producing a rigid PUR or PIR foam comprising reacting:
a polyisocyanate;
water;
a surfactant;
a polyol stream comprising 0.0 to 99.0 wt % of a polyester polyol and 1.0 to 100.0 wt % of the first polyol of claim 1, 25, or 28.
optionally, a urethane catalyst, an isocyanurate catalyst, or both;
optionally, a blowing agent; and
optionally, a flame retardant.

30. A first polyol made by the process of claim 1.

31. A rigid PUR or PIR foam made by the process of claim 29.

32. The process of claim 29 wherein the polyisocyanate has an NCO functionality in the range of 2.0 to 3.0.

33. The process of claim 29 wherein the polyisocyanate is aromatic or aliphatic.

34. (canceled)

35. The process of claim 33 wherein the aliphatic polyisocyanate is selected from hexamethylene diisocyanate, hydrogenated MDI, cyclohexane diisocyanate, isophorone diisocyanate, trimethyl or tetramethylhexamethylene diisocyanate.

36. The process of claim 33 wherein the aromatic polyisocyanate has an NCO functionality in the range of 2.3 to 3.0.

37. (canceled)

38. (canceled)

39. The process of claim 29 wherein the polyester polyol comprises recurring units of a phthalimide-functional diacid, a phthalimide-functional diol, or a combination thereof.

40. The process of claim 29 wherein the water is used in an amount within the range of 0.1 to 3 wt. % based on the amount of polyester polyol in the rigid foam formulation.

41-46. (canceled)
